(19) United States
(12) Patent Application Publication
(10) Pub. No.: US 2021/0250337 A1
(43) Pub. Date: Aug. 12, 2021

(54) METHOD AND DEVICE FOR MATCHING EVALUATION OF STRUCTURED DATA SETS PROTECTED BY ENCRYPTION

(71) Applicant: COSMIAN TECH, Paris (FR)

(72) Inventors: Bruno GRIEDER, Clichy (FR); Anca Nitulescu, Paris (FR); Michele Sartori, Paris (FR)

(21) Appl. No.: 17/169,895

(22) Filed: Feb. 8, 2021

(30) Foreign Application Priority Data
Feb. 6, 2020 (FR) 2001187

(51) Int. Cl. H04L 29/06; H04L 9/08; H04L 9/30; H04L 9/00

(52) U.S. Cl. CPC H04L 63/0435; H04L 9/008; H04L 9/30; H04L 9/085

(57) ABSTRACT

The invention relates to a secure and reliable manner to verify and combine data coming from different sources of data. In particular, the invention relates to the limitation of the operations of matching evaluation of structured data sets and combination of these structured data sets to specific clients, and the protection of the identifiers used for the matching evaluation and combination operations so that the clients cannot access the identifiers in clear.

### CROSS REFERENCE TO RELATED APPLICATIONS

This application claims priority under 35 U.S.C. ¬ß119(a) to French patent application 2001187 filed on Feb. 6, 2020, the entire teaching of which is incorporated herein by reference.

### BACKGROUND OF THE INVENTION

### Field of the Invention

The present invention relates to a secure and reliable manner to verify and combine data coming from different sources of data. In particular, the invention relates to the limitation of the operations of matching evaluation of structured data sets and combination of these structured data sets to specific clients, and to the protection of the identifiers used for the matching evaluation and combination operations so that the clients cannot access the identifiers in clear.

### Description of the Related Art

At present, due to the increased connectivity between data, service providers and distributed information storage, it is necessary to secure the exchange of information between data providers and the storage at third parties thereof. In particular, it is increasingly necessary that a third party (also called “client”, “client device” or “data consumer”) can access data coming from different sources, stored at different data providers (also called “data source device”).

In a frequent scenario, a client wants to recover data coming from different data source devices and to verify if these different source devices have stored data relating to a same identifier, for example relating to a specific individual. For example, this matching evaluation operation may be used to verify the solvency of a person by comparing information of different origins (for example bank information, insurance information, official registers, etc.).

It may be desirable to combine the data from the different data source devices to obtain an enriched data set including these various data. In the context of databases, such a combination of data is called a “join” operation. In a join operation, different tables, for example data sets from different source devices, are combined by means of a comparison of one or several specific columns, also called “identifier” or “join key”.

In this way of proceeding, a problem lies in the fact that the identifiers used to perform the combination often contain sensitive, or even personal information. For example, the social security number of a person may be used to recover information from a bank or an insurance company: in such a case, the bank data and the insurance contracts themselves contain no personal information, but the identifier used to combine these two data includes sensitive information that permit unambiguous identification of an individual. Actually, and due to more and more severe personal data protection constraints, the client (the data consumer) must not be able to reach these identifiers in clear.

Most common techniques used to protect sensitive identifiers are based on application of a hash function, deterministic encryption or salting, i.e. randomizing the identifiers. A hash function consists in applying a one-way function that, from data of arbitrary size and often great size, will output values of limited or fixed size called “digital footprints”. In some configurations, a random data (called “salt”) is used as an additional input to a one-way hash function that transforms the identifiers to protect them against “dictionary” attacks from third parties. With this technique, a data source device can generate protected identifiers which the client cannot access in clear while being nevertheless able to verify if those protected identifiers are present in data sets of one or several data source devices. However, with this technique, the identifiers are not protected against dictionary attacks from other data source devices. Another drawback of the classical techniques is that, at present, any third party having access to the identifiers has the possibility to execute a combination operation (also called “join operation”), since this operation is not limited to specific clients. Moreover, with these known techniques, a data source device can also impersonate the identity of other data source devices and generate data on behalf thereof.

US 2018/081960 A1 and US 2015/082399 A1 describe such known techniques, which however have for drawback not to allow determining, from encrypted digital footprints, whether values (in clear) of two identifiers respectively represented by these encrypted footprints are identical or not, without however having access to these identifiers in clear.

### BRIEF SUMMARY OF THE INVENTION

The object of the invention is to remedy the drawbacks of prior art techniques.

This object is achieved by a method for matching evaluation of a first structured data set from a first data source device with a second structured data set from a second data source device, implemented in a client device, including the following steps:

a. exchange of an encryption key between the client device, the first data source device and the second data source device;
b. reception of the first structured data set from the first data source device, the first structured data set including a first encrypted digital footprint generated from a first digital footprint and the encryption key, the first digital footprint being generated from a first identifier in clear and a secret key that is shared between the first and second data source device;
c. reception of the second structured data set from the second data source device, the second structured data set including a second encrypted digital footprint generated from a second digital footprint and the encryption key, the second digital footprint being generated from a second identifier in clear and the shared secret key;
d. comparison of the first encrypted digital footprint of the first structured data set with the second encrypted digital footprint of the second structured data set in order to determine if the first identifier in clear is identical to the second identifier in clear without having access to the first and second identifiers in clear, the first digital footprint of the first structured data set having a value different from that of the second encrypted digital footprint of the second structured data set.

The encryption key may be a public key of the client device.

The comparison step may then be based on the decryption of the first encrypted digital footprint of the first structured data set and of the second encrypted digital footprint of the second structured data set by means of a private key of the client device.

The encryption key may also include a first symmetric key exchanged between the client device and the first data source device and a second symmetric key exchanged between the client device and the second data source device. The encryption key used to generate the first encrypted digital footprint of the first structured data set may be the first symmetric key, and the encryption key used to generate the second encrypted digital footprint of the second structured data set may be the second symmetric key.

The comparison step may in this case be based on the decryption of the first encrypted digital footprint of the first structured data set by means of the first symmetric key and the decryption of the second encrypted digital footprint of the second structured data set by means of the second symmetric key.

The encryption key may also be a symmetric key shared between the client device, the first data source device and the second data source device. The first encrypted digital footprint of the first structured data set may then further be generated from a first random value and the first structured data set may further include the first random value, and the second encrypted digital footprint of the second structured data set may further be generated from a second random value and the second structured data set may further include the second random value. The comparison step may then be carried out by means of the first and second random values.

In this case, the comparison step may be based on the decryption of the first encrypted digital footprint of the first structured data set by means of the first random value and the shared symmetric key, and the decryption of the second encrypted digital footprint of the second structured data set by means of the second random value and the shared symmetric key.

The comparison step may further be based on a homomorphic property of an encryption algorithm used to generate the first encrypted digital footprint of the first structured data set and to generate the second encrypted digital footprint of the second structured data set.

In all the preceding cases, the first digital footprint may further be generated from a given functional value, this given functional value defining the possible functions of use of the shared secret key, and the second digital footprint may further be generated from the given functional value.

The comparison step may include a homomorphic operation of the first encrypted digital footprint of the first structured data set with the second encrypted digital footprint of the second structured data set.

In this case, the comparison step may further include an operation of checking, by means of the private key of the client device, if the result of the homomorphic operation meets a given property and, if the result of the homomorphic operation meets the given property, then the first identifier in clear is identical to the second identifier in clear.

Advantageously, in all the preceding cases, the first and/or the second structured data sets may further include data associated with the first encrypted digital footprint of the first structured data set and with the second encrypted digital footprint of the second structured data set, the method then including a step of inserting, into a join set, data associated with the first encrypted digital footprint of the first structured data set and/or data associated with the second encrypted digital footprint of the second structured data set when the result of the comparison step determines that the first identifier in clear is identical to the second identifier in clear.

In this latter case, the step of insertion into the join set may further insert the data associated with the first encrypted digital footprint of the first structured data set when the result of the comparison step determines that the first identifier in clear is not identical to the second identifier in clear.

In all the preceding cases, the first structured data set may include a plurality of first encrypted digital footprints and/or the second structured data set may include a plurality of second encrypted digital footprints, the comparison step being carried out for one or several first encrypted digital footprints of the first structured data set and one or several second encrypted digital footprints of the second structured data set.

The first structured data set may then include a plurality of first encrypted digital footprints and/or the second structured data set may include a plurality of second encrypted digital footprints, the comparison step and the step of insertion into a join set being executed for one or several first encrypted digital footprints of the first structured data set and one or several second encrypted digital footprints of the second structured data set.

Finally, in all the cases hereinabove, the structured data sets may be data tables or databases; and/or the secret key that is shared between the first and the second data source devices may be established using a key exchange cryptographic protocol.

The invention has also for object a method for providing a structured data set to a client device, implemented in a data source device, the method including the following steps:

i. exchange of an encryption key between the client device, the data source device and a second data source device;
ii. creation of a digital footprint from an identifier in clear and a secret key that is shared with the second data source device;
iii. generation of an encrypted digital footprint from the digital footprint and the encryption key; and
iv. sending to the client device of a structured data set including the encrypted digital footprint in order to carry out a matching evaluation with another structured data set coming from the second data source device.

According to various possible implementations of this method:

the encryption key is a public key of the client device;

the encryption key includes a symmetric key shared between the client device and the data source device, the encryption key used to generate the encrypted digital footprint of the structured data set being the symmetric key;

the encryption key is a symmetric key shared between the client device and the data source device, the encrypted digital footprint of the structured data set being further generated from a random value and the structured data set further including the random value;

the structured data set includes a plurality of encrypted digital footprints;

the structured data set further includes data associated with the encrypted digital footprint.

The invention has also for object a device configured to implement one of the above-described methods

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

An exemplary embodiment of the present invention will now be described with reference to the appended drawings in which the same references denote, throughout the figures, identical or functionally similar elements:

FIG. 1 illustrates a join operation according to the prior art.

FIG. 2 illustrates the creation of a common secret between two data source devices.

FIG. 3 illustrates the method of evaluating structured data sets received from data source devices and combining these structured data sets according to a first embodiment of the invention.

FIG. 4 illustrates the method of evaluating structured data sets received from data source devices and combining these structured data sets according to a second embodiment.

FIG. 5 illustrates the method of evaluating structured data sets received from data source devices and combining these structured data sets according to a third embodiment.

FIG. 6 illustrates, by way of example, the operations performed at each data source device according to the first embodiment.

FIG. 7 illustrates, by way of example, the operations performed at the data client device according to the first embodiment.

### DETAILED DESCRIPTION OF THE INVENTION

The invention relates to how to securely and reliably ensure the matching evaluation and the combination of structured data sets coming from different data source devices. In particular, the invention relates to how to limit operations of matching evaluation and combination of structured data sets to specific client devices, and to protect the item(s) of information used for these operations, for example one or several identifiers, in such a manner that the client device cannot access the information in clear, for example the identifiers as such. Thus, the solution according to the present invention provides the two following guarantees in terms of security: 1°) absence of access to the information in clear (for example, the identifiers) by a client device and 2°) control, by means of cryptographic techniques, of the client devices that are allowed to perform operations (for example, the matching evaluation, the combination, etc.) on the information used for these operations (for example, the identifiers) and/or on the data that are associated thereto.

To obtain such security guarantees, the invention uses the functional encryption properties. Functional encryption is a cryptographic technique that enables entities to execute specific operations on encrypted data and to obtain the result of these operations by using a specific key without having access to the data in clear. Functional encryption generalizes public key encryption as follows: an encryption of a message m, with a functional decryption key associated with the function f, outputs the value f(m) without revealing any additional information about the encrypted message m. Functional encryption allows for evaluation on encrypted inputs and gives access to the result in clear, but never reveals the inputs of the computation nor the intermediate values. Performing computations on the data and obtaining the results of these computations is possible only for entities authorized by an authority that generates the specific keys associated with the specific computations.

The encryption protocol according to the present invention essentially includes:

the anonymization of the item(s) of information used for implementing the data matching evaluation and combination method, for example the identifier(s), using a hash function, in order to create collision-resistant digital footprints of this information, which prevent dictionary attacks on the digital footprints and avoid the access to the information in clear by a client device;

the encryption of the digital footprints, using either a public key encryption (more expensive in practice) or a (symmetric) secret (randomized) key encryption (very efficient).

In the public key encryption schemes, also called asymmetric encryption schemes, two different keys are used to perform the encryption and the decryption. The encryption process is public, that is to say that anyone can use the public key of the recipient to encrypt the data. The decryption process is private, that it to say that only the real recipient, which has the associated secret key (decryption key) in its possession, is able to decrypt the encrypted texts that have been encrypted with the public key.

In the symmetric encryption schemes, unlike the public key encryption schemes, the same key is used for the encryption and the decryption. Actually, this key must be kept secret and shared only between the sender and the recipient of the message.

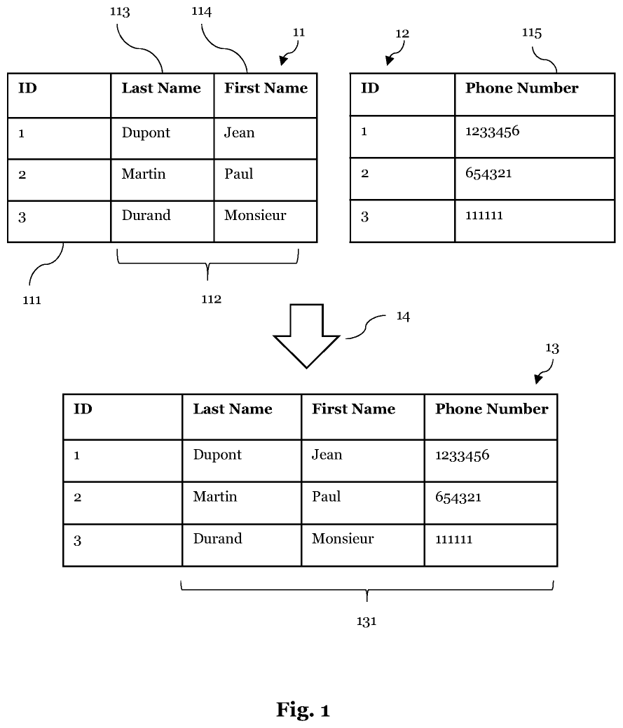

FIG. 1 illustrates a operation of combining (or joining) structured data sets according to the prior art, in particular a join between two structured data sets to obtain a combined data set, also called join set. The structured data sets are for example data tables or databases. This join operation is carried out from join information, i.e. one or several identifiers present in each of the structured data sets.

Several types of join operations are known in the prior art to combine data coming from different structured data sets and to create a join set:

(Internal) join: returns the records whose identifiers match with each other in both structured data sets;
Left (external) join: returns all the records of a structured data set, for example of the data table illustrated on the left in FIG. 1, and the matching records (i.e. having the same identifier(s)) of the other structured data set, for example of the table illustrated on the right in FIG. 1;
Right (external) join: returns all the records of a structured data set, for example of the data table illustrated on the right in FIG. 1, and the matching records (i.e. having the same identifier(s)) of the other structured data set, for example of the table illustrated on the left in FIG. 1;
Full (external) join: returns all the records of the structured data sets, for example of the table illustrated on the right and the table illustrated on the left in FIG. 1, with their match if this match exists.

A combination operation is performed on a given column or a column set called “item(s) of information”, “item(s) of join information”, identifier(s)” or, in database terminology, “data join keys”. In the following of the description, the term “identifier” will be used to denote information allowing for the matching between two or more structured data sets. The identifiers may be, for example, the last name, the first name, an identification number, etc., and may be used to implement the method of matching evaluation and/or combination of structured data sets according to the invention.

In the following of the description, by way of exemplary embodiment of the invention, data tables will be considered as structured data sets and an identifier as information for the matching evaluation and/or the combination.

In the example of FIG. 1, data table 11 is joined to data table 12 by means of the identifiers present in column ID (column 111). Since, in the specific example illustrated in FIG. 1, data tables 11 and 12 both have the same number of records (illustrated by the number of lines) and the same identifiers, the execution of any one of the four join operations exposed hereinabove will give the same result. This result is illustrated by data table 13, also called join set, after the join operation 14. Data table 11 includes, in addition to a column of identifiers ID 111, data 112 structured into two columns called “last name” 113 and “first name” 114, respectively. Thus, a last name and a first name are associated with each identifier of column 111. Data table 12 includes, in addition to a column of identifiers ID, data 115 structured into one column called “phone number”. Thus, one phone number is associated with each identifier of column ID. Data table 13, i.e. a join set, includes, for each identifier of the column of identifiers ID, data 113, 114 and 115, from data tables 11 and 12, respectively (reference 131 is FIG. 1).

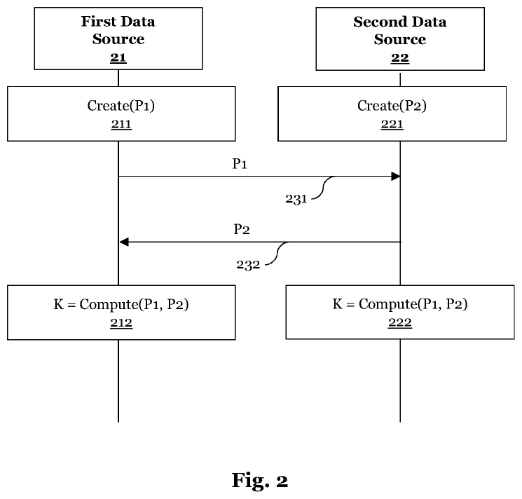

FIG. 2 illustrates a method of creating a common secret between two data source devices, also called “shared secret key” or “shared secret”. This method is also known as “key exchange”, “key distribution” or “key negotiation”. A key exchange is a process in which several (for example, two) devices agree on a common cryptographic key, without ever revealing it. This may be obtained by communicating intermediate public keys (interactive protocols) or by publishing public keys in a register (non-interactive protocols), and by local computations by each of the data source devices with these keys in order to create a shared key. This shared key represents a secret shared between two data source devices. An example of key exchange scheme very often used in practice is the Diffie-Hellman key exchange.

An interactive version of a key exchange protocol is illustrated in FIG. 2. According to this protocol, a first data source device 21 (also called first data source) and a second data source device 22 (also called second data source) exchange data to establish a shared secret key K. For that purpose, during steps 211 and 221, first data source device 21 creates a value P1 and second data source device 22 creates a second value P2. According to the Diffie-Hellman key exchange protocol, these values may correspond to P1=g^{a} and P2=g^{b}, a and b being random values and g a generator from a finished group. During steps 231, 232, first data source device 21 sends value P1 to second data source device 22, and second data source device 22 sends value P2 to the first data source device. These steps are followed with a step of computing the shared secret key K in the first and the second structured data sets, respectively (steps 212 and 222). In particular, first data source device 21 computes the shared secret key K on the basis of its own value P1 and of the received value P2. According to the Diffie-Hellmann protocol, the shared secret key K may be computed according to formula K=(g^{a})^{b}. Second data source device 22 itself computes the shared secret key K on the basis of its own value P2 and of the received value P1. According to the Diffie-Hellman protocol, the shared secret key K may be computed according to formula K=(g^{b})^{a}. The two data source devices are then in possession of a shared secret key that can be used for later encryption operations.

As an alternative of this interactive key exchange protocol, called “non-interactive protocol”, the two data source devices do not exchange directly the values P1 and P2 but publish these values in a public register. Thus, first data source device 21 publishes its value P1 in the public register and recovers value P2 of second data source device 22 from this public register, and second data source device 22 publishes its value P2 in the public register and recovers value P1 of first data source device 21 from this public register. The other steps of the protocol are similar to the interactive version of the key exchange protocol illustrated in FIG. 2. Moreover, a combination of these protocols may be contemplated.

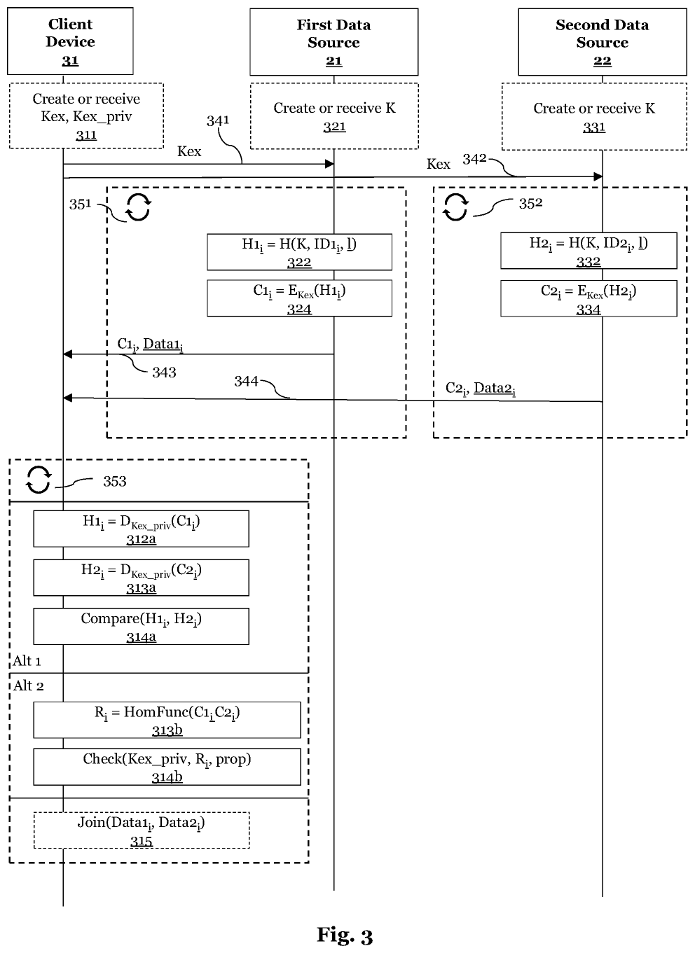

With reference to FIGS. 3 to 5, different methods of matching evaluation and combination of two or more structured data sets received from two or more data source devices are illustrated. In these figures, the blocks in dotted lines and the underlined parameters refer to optional features that are not essential for the matching evaluation and the combination of structured data sets.

FIG. 3 illustrates the matching evaluation and combination of structured data sets received from two data source devices according to a first embodiment of the invention. In this embodiment, the encryption of the identifiers at the data source devices is performed using a public key encryption scheme. The use of a public key encryption scheme makes the scheme particularly flexible and evolutive.

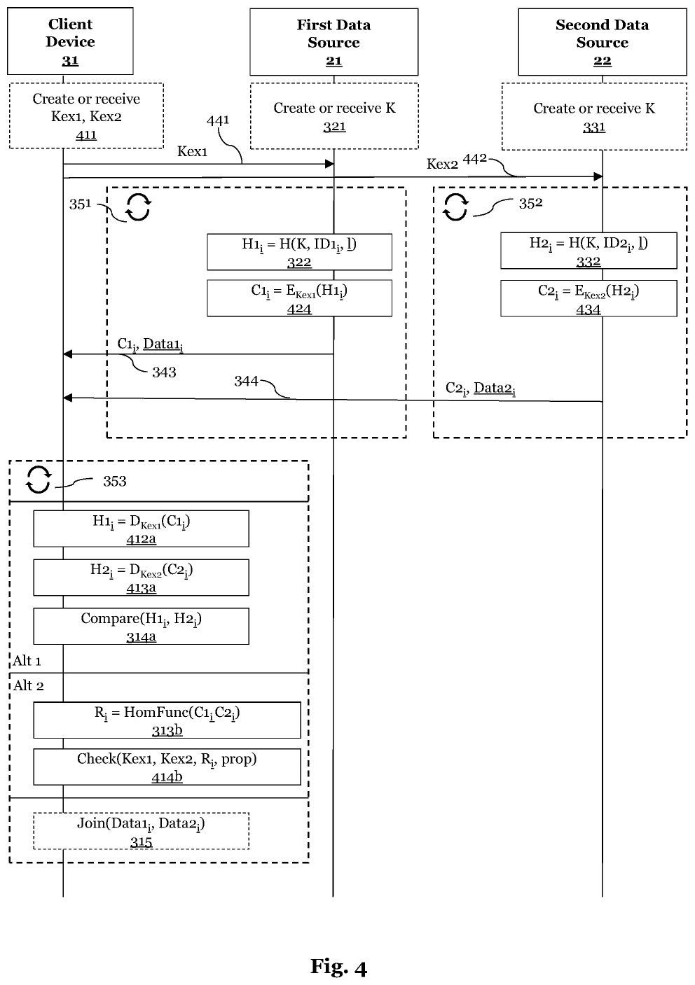

In the particular embodiment of FIG. 3, a first data source device 21 (also called “first data source”) and a second data source device 22 (also called “second data source”) provide to a client device 31, also called “consumer device”, structured data sets including identifiers. It will be noted that, although FIG. 3 illustrates, just as FIGS. 4 to 7, two data source devices, it is possible to allow for a greater number of data source devices providing structured data sets to the client device 31.

During steps 321 and 331, the first and second data source devices create or receive a shared secret key K. The shared secret key K may for example be created by one of the protocols described hereinabove in refence to FIG. 2. As an alternative, the shared secret key K may be provided to data source devices 21 and 22 by a third party, for example a thrusted third party managing the keys of the data source devices.

Moreover, client device 31 can create or receive, during step 311, keys Kex and Kexpriv. In the embodiment described, keys Kex and Kexpriv constitute a public key/private key pair of a public key encryption scheme. Preferably, this scheme has probabilistic encryption properties. The probabilistic encryption properties have for effect that, each time a same message is encrypted, a different encrypted result is obtained. This is obtained, for example, by the introduction of a random value into the encryption process. According to a particular embodiment of the invention, an asymmetric key encryption algorithm, such as the ElGamal encryption algorithm, is used, which has probabilistic encryption properties.

Client device 31 may, for example, create locally keys Kex and Kexpriv, or create them from a thrusted infrastructure delivering and/or managing the keys on behalf of client device 31. Other types of key distribution infrastructure may also be contemplated.

According to another embodiment, key Kex, also called encryption key Kex, can be exchanged between client device 31 and first and second data source devices 21, 22. This exchange of encryption key Kex may be made in different manners. For example, during steps 341 and 342, encryption key Kex may be sent by client device 31 to first and second data source devices 21, 22. According to an alternative, encryption key Kex may be published in a public register and received or recovered by first and second data source devices 21, 22. A combination of these two key exchange protocols, or the use of different key exchange protocols, may also be contemplated.

Then, data source devices 21, 22 prepare the sending of structured data sets to client device 31. The structured data set of each data source device 21, 22 includes at least one identifier. Moreover, the structured data sets may also include data associated with the at least one identifier of the structured data set of first and/or second data source devices 21, 22.

To be sure that client device 31 can at no time read in clear the identifiers sent by data source devices 21, 22, the identifiers are made anonymous at data source devices 21, 22. This operation is performed using a hash function, which is a non-injective function that, from data of arbitrary size and often great size, will output values of limited or fixed size called “digital footprints”. Since a hash function is deterministic—which means that, for a given input value it always generates the same digital footprint —, the digital footprints are not protected against dictionary attacks, i.e. brute force attacks enabling the breaking of an encryption by trying to determine the value in clear by means of various known possibilities, such as words of a dictionary. Actually, a fraudulent entity can operate dictionary attacks and find the identifiers in clear. Such a fraudulent identity can act as a false data source device delivering false information to client device 31, or as a false client device liable to use the identifiers in clear to obtain more elements about the information received by data source devices 21, 22. Moreover, other data source devices, which already know the identifiers in clear but which, although not allowed to deliver information to a client device, could impersonate one of data source devices 21, 22 in order to deliver false information to client device 31.

To ensure a protection against attacks of the dictionary type or by impersonation of a data source, the hash function uses the secret key K shared between the authorized data source devices 21, 22 to generate a digital footprint. The shared secret key K is used as a “salt” and also ensures a protection against data source devices that are not in possession of the shared secret key K.

Moreover, to limit or specify the matching evaluation and/or combination operations allowed to a client device 31, the hash function may be executed with, as a parameter, a label l, also called given functional value. A label may be for example a string of characters that will be concatenated to the identifier before the hash function is carried out. Hence, it is possible to use a first label to create a first digital footprint that will be different from the second digital footprint created using a second label, different from the first one. However, according to an embodiment of the invention, the two data source devices 21, 22 must use the same label to allow a client device 31 to perform an operation on the structured data sets received from data source devices 21, 22. Using labels also makes it possible to provide a greater flexibility as regards the data on which client device 31 can perform matching evaluation and combination operations. Indeed, this label may be used to specify the identifiers. For example, identifiers of first data source device 21 and second data source device 22 relating to data of year 2019 may receive a label “2019” and identifiers relating to data of year 2020 may receive a label “2020”. From then on, client device 31 may perform operations on the so-received identifiers relating, for example, only to data of year 2019 of first data source device 21 and second data source device 22 that carry the label “2019” or to data of year 2020 of first data source device 21 and second data source device 22 that carry the label “2020”, but client device 31 cannot perform operations on data of year 2019 of first data source device 21 with data of year 2020 of second data source device 22, because the digital footprints relating to a same identifier but having a different label won't match with each other.

More generally, using labels makes it possible to limit the operations to some sub-sets of the structured data sets of the data source devices. Moreover, using labels increases the security of the identifiers because, even if information about the digital footprints computed with a given label is known, it is not possible to recover information about digital footprints computed with different labels.

In the particular example of FIG. 3, during step 322, first data source device 21 generates a first digital footprint H1₁ by applying a hash function having for parameter a first identifier ID1₁ of the first data source device, the shared secret key K and optionally a label l (H1₁=H(K, ID1₁, l)). During step 332, second data source device 22 generates a second digital footprint H2₁ by applying a hash function having for parameter a second identifier ID2₁ of the second data source device, the shared secret key K and optionally a label l (H2₁=H(K, ID2₁, l)).

Then, digital footprints H1₁, H2₁ are encrypted in such manner that only client device 31 can access the digital footprints and use them to perform operations.

Thus, in the particular example of FIG. 3, first data source device 21 generates a first encrypted digital footprint C1₁ at step 324 from first digital footprint H1₁ of the first data source device and encryption key Kex (C1=E_{Kex}(H1₁)), and second data source device 22 generates a second encrypted digital footprint C2₁ at step 334 from second digital footprint H2₁ of the second data source device and the same encryption key Kex (C2₁=E_{Kex}(H2₁)).

As indicated hereinabove, in addition to encrypted digital footprints C1₁, C2₁, the structured data sets sent to client device 31 may also include data Data1₁, Data2₁ associated with the encrypted digital footprints. For example, first data source device 21 may include data Data1₁ associated with first encrypted digital footprint C1₁, and/or second data source device 22 may include data Data2₁ associated with second encrypted digital footprint C2₁.

To ensure an increased security of the sent data Data1₁, Data2₁, these data may also be encrypted. This is particularly important when data Data1₁, Data2₁ include sensitive and/or personal information. Encryption of data Data1₁, Data2₁ can be made using the same encryption key Kex as that which has already be used to encrypt digital footprints. As an alternative, it is possible to use a different encryption key. For example, a different symmetric encryption may be used to encrypt the data in order to improve the performance, since symmetric encryption/decryption is generally faster than asymmetric encryption/decryption.

According to a particular embodiment, when the structured data set of first data source device 21 includes a plurality of identifiers and if associated data exist, the digital footprint generation and encryption steps (steps 322 and 324) are repeated for each identifier and for each associated data (if the associated data have to be encrypted). This iteration of steps 322 and 324 is illustrated in FIG. 3 by the sign denoted 351.

The elements or values that change from one iteration to the next one are denoted by an index i. As the reiteration of these steps occurs only when there are a plurality of identifiers and associated data (if these latter exist), the respective indices of the elements and values are underlined to indicate their optional nature. The same remarks apply to second data source device 22, the repetition sign being denoted 352.

Then, the structured data set of first data source device 21 is sent to client device 31 (step 343). In particular, first data source device 21 sends first encrypted digital footprint C1₁ and potentially associated data Data1₁ to client device 31. When the structured data set includes a plurality of encrypted footprints, these latter, as well as associated data Data1₁ (if they exist), are sent to client device 31 at step 343 as first structured data set.

The same remarks apply to second data source device 22, which sends second encrypted digital footprint C2₁ and potentially associated data Data2₁ forming the second structured data set, to client device 31 (step 344). When the structured data set includes a plurality of encrypted digital footprints, these latter, as well as associated data Data2₁ (if they exist), are sent to client device 31 at step 344 as second structured data set.

At the following step, client device 31 receives the first and second structured data set including encrypted digital footprints C1₁, C2₁, and potentially associated data Data1₁, Data2₁ or, in case of a plurality of encrypted digital footprints, the plurality of encrypted identifiers C1ᵢ, C2ᵢ and a plurality of associated data Data1ᵢ, Data2ᵢ. According to an alternative embodiment, first data source device 21 sends a first digital footprint C1₁ (potentially including associated data Data1₁), and second structured data set 22 sends a plurality of encrypted digital footprints C2₁ (with potentially a plurality of associated data Data2₁) or vice versa.

To verify that the identifier of first data source device 21 corresponds to the identifier of second data source device 22, client device 31 compares the encrypted digital footprints C1₁ and C2₁.

According to a first alternative embodiment Alt1, the comparison includes decryption of the encrypted digital footprints C1₁, C2₁ by client device 31 in order to obtain digital footprints H1₁, H2₁ (steps 312a, 313a). For that purpose, at step 312a, client device 31 decrypts first encrypted digital footprint C1₁ by means of private key Kex_priv, to obtain first digital footprint H1₁ of first data source device 21, and at step 313a, client device 31 decrypts second encrypted digital footprint C2₁ by means of private key Kex_priv, to obtain second digital footprint H2₁ of second data source device 22. During the following step, client device 31 compares digital footprints H1₁, H2₁ in order to determine whether identifiers ID1₁, ID2₁ are identical or not (step 314a). If digital footprints H1₁, H2₁ are identical (H1₁=H2₁), then it is determined that identifiers ID1₁ and ID2₁ are also identical (ID1₁=ID2₁).

According to another alternative embodiment Alt2, the comparison includes the use of a homomorphic function. This alternative can be used when the encrypted digital footprints have been encrypted by means of a same encryption algorithm having homomorphism properties. Homomorphism properties enable computations on encrypted texts, with generation of an encrypted result that, once decrypted, matches with the result of the operations in the same way as if these latter had been made on the text in clear (for example, C(ID1)+C(ID2)=C(ID1+ID2)). The use of an encryption algorithm having homomorphic properties provides the advantage that encrypted digital footprints C1₁, C2₁ do not need to be decrypted, which can improve the security and the processing time.

The following example illustrates a homomorphic encryption scheme implemented by two data source devices:

### First Data Source Device:

First encryption key: 11
   ID: 1, first name: Jean; encrypted ID: 1+11=12
   ID: 2, first name: Paul; encrypted ID: 2+11=13
   ID: 3, first name: Monsieur; encrypted ID: 3+11=14

### Second Data Source Device:

Second encryption key: 20
   ID: 2, last name: Dupont; encrypted ID: 2+20=22
   ID: 4, last name: Martin; encrypted ID: 4+20=24
   ID: 5, last name: Durand; encrypted ID: 5+20=25

The records of the first data source device each include an identifier ID and a first name. The first data source device further has a first encryption key that is used to encrypt the identifiers ID in order to produce encrypted identifiers ID. The records of the second data source device each include an identifier ID and a last name. The second data source device also has a second encryption key, which is used to encrypt the identifiers ID in order to produce encrypted identifiers ID.

The encrypted identifiers ID can later be verified by a client device thanks to a homomorphic operation and a specific key, as follows:

### Client Device:

Specific key: 9
   Encrypted ID of second data source device 22—encrypted ID of first data source device 13=9.

In this example, the homomorphic operation is a subtraction and the result can be compared to the specific key. The specific key is determined for example from the encryption keys. For example, the specific key is created by difference between the two encryption keys (20−11=9). If the result of the operation and the specific key are identical, then it is determined that the encrypted identifiers ID are identical. The data associated with these identifiers can thus be joined, which leads to the name “Paul Dupont”.

In the example of FIG. 3, the client device executes the comparison step by applying, on the one hand, the homomorphic function at step 313b, using the encrypted digital footprints C1₁ and C2₁ to produce a result R₁. This homomorphic function may include subtraction, addition, multiplication and/or division, etc. Then, the comparison step applies, on the other hand, a function making it possible to determine whether the result R₁ meets or not a predefined property prop using private key Kex_priv of client device 31 (step 314b). If the result meets predefined property prop, then identifiers ID1₁ and ID1₂ are identical.

Predefined property prop may include a specific value, for example 0 or 1, and the check step (step 314b) may include decrypting result R₁ and comparing decrypted result R₁ with the specific value. For example, if decrypted result R₁ is equal to the specific value, then identifiers ID1₁ and ID2₁ are identical. If not, identifiers ID1₁ and ID2₁ are not identical. According to an alternative embodiment, a ElGamal encryption algorithm having homomorphism properties as regards multiplications and divisions can be used to evaluate if a result meets a predefined property prop, for example is equal to a predefined value.

If client device 31 has determined that identifiers ID1₁ and ID2₁ are identical, then data source devices 21 and 22 include a record having identifier ID1₁ and identifier ID2₁, respectively, which are identical. As a function of this evaluation, later operations can be carried out.

For example, client device 31 may use the identical identifiers ID1₁, ID2₁ to perform a combination (join) operation (step 315) in order to generate a join set. The different possibilities of join operation have been presented hereinabove in relation with FIG. 1, and may also be applied to the data Data1₁, Data2₁ received from the first and the second data source device 21, 22, respectively.

If a plurality of encrypted digital footprints C1ᵢ C2ᵢ are received by client device 31, the latter can execute the comparison step for the plurality of encrypted digital footprints C1ᵢ, C2ᵢ. Moreover, if a plurality of data Data1ᵢ, Data2ᵢ associated with the encrypted identifiers C1ᵢ, C2ᵢ are received by client device 31, the latter can perform the join operations on the plurality of data Data1ᵢ, Data2ᵢ. Such an iteration for a plurality of encrypted digital footprints C1ᵢ, C2ᵢ, and possibly data Data1ᵢ, Data2ᵢ, is illustrated by the sign denoted 353.

FIG. 4 illustrates a method of matching evaluation and combination of structured data sets received from data source devices according to a second embodiment of the invention.

In this embodiment, the encryption of the identifiers at the data source devices is performed with a symmetric encryption scheme, the data source devices using distinct keys. The advantage of using a symmetric encryption scheme is the possibility of performing the encryption and decryption processes with a reduced processing time, with respect to the public key encryption schemes.

However, the symmetric encryption schemes are generally deterministic encryption schemes. In such a scheme, every time a same message is encrypted, the same resulting encrypted text is obtained. Actually, by comparing (without being in possession of the decryption key) resulting encrypted texts, it is possible to determine that the same original text in clear has been encrypted into two identical encrypted texts. However, the text in clear cannot be recovered without the decryption key. Hence, with a symmetric encryption scheme in which each of the data sources uses a same encryption key and produces identical encrypted identifiers, a third party can easily perform a matching evaluation operation and/or other operations (in particular, combination operations) without knowing the decryption key and hence without authorization. To counter this risk, the second embodiment uses distinct keys for each data source, which provides the additional advantage not to have to exchange an additional random value to be certain that the encrypted values coming from different data source devices are not identical.

Only the steps that are different from those of the first embodiment will be described in detail hereinafter. As for the rest, reference will be made to the first embodiment.

At step 411, client device 31 creates or receives a first and a second symmetric keys Kex1, Kex2 for each data source device 21, 22, respectively. The keys may be created locally, or may come from a key register located remote from client device 31. Then, client device 31 sends first symmetric key Kex1 to first data source device 21 (step 441), and second symmetric key Kex2 to second data source device 22 (step 442). According to an alternative embodiment, client device 31, first data source device 21 and second data source device 22 can obtain the respective symmetric keys Kex1, Kex2 of a key management infrastructure.

At step 424, first data source device 21 encrypts first digital footprint H1₁ of first data source device using first symmetric key Kex1 (C1₁=E_{Kex1}(H1₁)) and, at step 434, second data source device 22 encrypts second digital footprint H2₁ of second data source device using second symmetric key Kex2 (C2₁=E_{Kex2}(H2₁)).

According to a first alternative embodiment Alt1, the comparison step includes the decryption of encrypted digital footprints C1₁, C2₁ by client device 31 in order to obtain the first and the second digital footprints H1₁, H2₁ (steps 412a and 413a). In particular, at step 412a, client device 31 decrypts first encrypted digital footprint C1₁ to obtain first digital footprint H1₁ of data source device 21 using first symmetric key Kex1 and, at step 413a, client device 31 decrypts second encrypted digital footprint C2₁ to obtain second digital footprint H2₁ of second data source device 22 using second symmetric key Kex2.

According to a second alternative embodiment Alt2, the comparison step includes the use of homomorphism properties of the encryption algorithm that has been used to encrypt digital footprints H1₁, H2₁. The check 414b is based on symmetric keys Kex1, Kex2, on the result of the homomorphic operation and on predefined property prop. For example, a specific relationship between the two symmetric keys Kex1, Kex2 can be used to check the result of the homomorphic operation. In particular, the specific relationship between the two symmetric keys Kex1, Kex2 can be used to create a specific key, as used in the example described hereinabove.

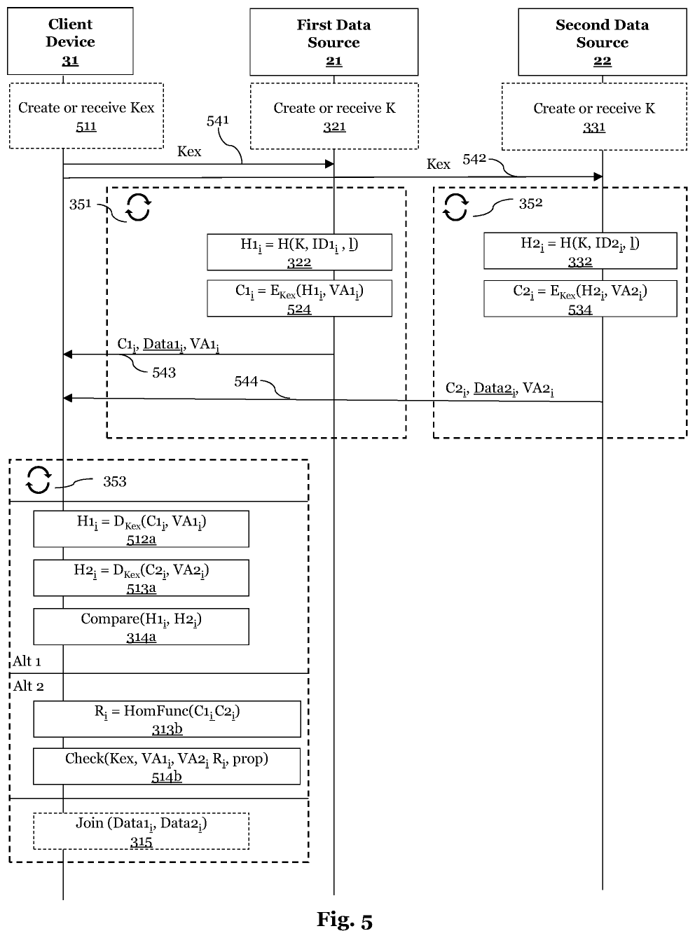

FIG. 5 illustrates a method of matching evaluation and combination of structured data sets received from data source devices according to a third embodiment of the invention.

In this embodiment, encryption of the identifiers at the data source devices is carried out by means of a symmetric encryption scheme, each data source device using the same key, which is randomized by means of a value that is specific to each data source device. Using a symmetric encryption scheme can provide the advantage of encryption or decryption with a reduced processing time with respect to a public key encryption scheme.

As in the case of FIG. 4, the use of a same encryption key in a deterministic encryption scheme leads to the same resulting encrypted text. To be certain that only authorized client devices are enabled to carry out the matching evaluation and other operations (in particular, combination operations), a random value is added to the digital footprints before encryption thereof. Thus, encryption of the same digital footprints won't give the same encryption digital footprint. With respect to the second embodiment, the third embodiment makes it possible to reduce the complexity as regards the key management thanks to the use of a unique key. Moreover, it is possible to increase the security using different random values for each digital footprint of a plurality of digital footprints. The increased security has for result that, even in presence of two identical digital footprints in a same data source device, for example in first data source device 21, the encrypted digital footprints will be different.

Only the steps that are different from those of the first embodiment will be described in detail hereinafter. As for the rest, reference will be made to the first embodiment.

At step 511, client device 31 creates or receives a unique symmetric key Kex. The key may be created locally or be obtained from a key register that is remote from client device 31. Then, client device 31 sends the unique symmetric key Kex to first data source device 21 and to second data source device 22 (steps 541 and 542). According to an alternative embodiment, client device 31, first data source device 21 and second data source device 22 may obtain the unique symmetric key Kex from a key management infrastructure.

At step 524, first data source device 21 encrypts first digital footprint H1₁ of first data source device using the unique symmetric key Kex and a first random value VA1₁ (C1₁=E_{Kex}(H1₁,VA1₁)), and at step 534, second data source device 22 encrypts second digital footprint H2₁ of second data source device using the unique symmetric key Kex and a second random value VA2₁ (C2₁=E_{Kex}(H2₁,VA2₁)). The random values add randomness to the encrypted value. In some cases, the random values may be added to the identifier in clear.

In the case of a plurality of digital footprints H1ᵢ and/or H2ᵢ, the first data source device 21 uses a different random value VA1ᵢ for each identifier of the plurality of digital footprints H1ᵢ, and the data source device 22 uses a different random value VA2ᵢ for each identifier of the plurality of digital footprints H2ᵢ. That way to proceed offers an increased security as regards the second embodiment of the invention because, even if two identical digital footprints (for example H1₁ and H1₂) are present in a same data source device, for example in first data source device 21, the encrypted digital footprints will be different (in this example, C1₁ won't be equal to C1₂).

To perform the comparison at client device 31, it is necessary to send the random values to client device 31 (steps 543 and 544). The sending can occur at the same time as encrypted digital footprints C1₁, C2₁, random values VA1ᵢ, VA2ᵢ and potential data Data1₁, Data2₁ as first and second data sets.

In a first alternative embodiment Alt1, the comparison includes the decryption of encrypted digital footprints C1₁, C2₁ by client device 31 in order to obtain digital footprints H1₁, H2₁ (steps 512a and 513a). At step 512a, client device 31 decrypts first digital footprint H1₁ of first data source device 21 using the unique symmetric key Kex and first random value VA1₁, and at step 513a, client device 31 decrypts second digital footprint H2₁ of second data source device 22 using the unique symmetric key Kex and second random value VA2₁.

In a second alternative embodiment Alt2, the comparison includes the use of homomorphism properties of the encryption algorithm that has been used to encrypt digital footprints H1₁, H1₂. The check 514b is based on the unique symmetric key Kex, on the result of the homomorphic operation and on predefined property prop. According to a particular embodiment, the check is further based on the two random values VA1ᵢ, VA2ᵢ. According to another embodiment, the two random values VA1ᵢ, VA2ᵢ may be used at step 313b of FIG. 5 by the homomorphic function and/or at the check step 514b.

If a plurality of digital footprints H1ᵢ, H2ᵢ and a plurality of random values VA1ᵢ, VA2ᵢ exist, the client device uses the random value that is associated with the digital footprint to perform the decryption.

Even if the first, second and third embodiments hereinabove have been described as separate embodiments, combinations of these embodiments are also possible. For example, a first data source device 21 may use a public key of client device 31, and a second data source device may use a key specific to the data source device or a common symmetric key with a random value. Generally, all combinations are possible insofar as that client device 31 has the information relating to the algorithm used to encrypt the specific data. However, if different encryption schemes are used, it is not possible to use the homomorphism properties.

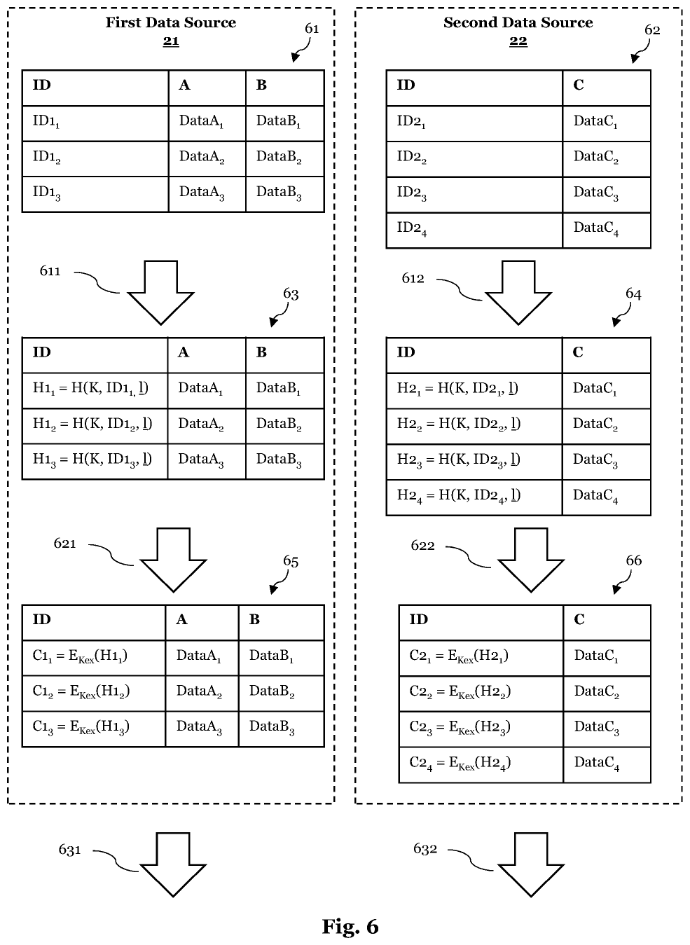

FIG. 6 illustrates the operations carried out at each data source device (also called data source) according to the first embodiment, in an example in which each data source device 21, 22 includes a plurality of identifiers and associated data.

In particular, the first data source device 21 includes three identifiers ID1₁, ID1₂, ID1₃ with associated data. Each identifier of first data source device 21 has A-type data and B-type data. For example, first identifier ID1₁ is associated with data DataA₁ and DataB₁.

The data are stored in clear in data table 61. In order to prepare the structured data sets to be sent to the client device, a hash function is applied to the identifiers at step 611 in order to generate a digital footprint for each identifier as illustrated in data table 63. Then, an encryption of the digital footprints is made at step 621 (in accordance with what was described in relation with FIG. 3), as illustrated in data table 65. According to a particular embodiment, the first data source device might not store data table 61 in memory but only data table 63, that is to say a table containing only the digital footprints and not identifiers in clear. Indeed, when the identifiers contain personal data, it may be preferable to store only the table containing the digital footprints of the identifiers, in particular to comply with regulations relating to the storage of personal data. In such a case, the data source devices have no longer access to the identifiers in clear, which further increases the security.

Second data source device 22 includes four identifiers ID2₁, ID2₂, ID2₃, ID2₄ with associated data. Each identifier of the second data source has C-type data. For example, first identifier ID2₁ is associated with data DataC₁. The structured data set is stored in clear in table 62. In order to prepare the sending of the structured data set, a hash function is applied to the identifiers at step 612, in order to generate a digital footprint for each identifier, as illustrated in data table 64. Then, an encryption of the digital footprints is carried out at step 622 (in accordance with the method described in FIG. 3), as illustrated in data table 66.

After implementation of these steps, the encrypted digital footprints and the associated data of each of the data source devices structured as structured data sets are sent to the client device (step 631 and 632).

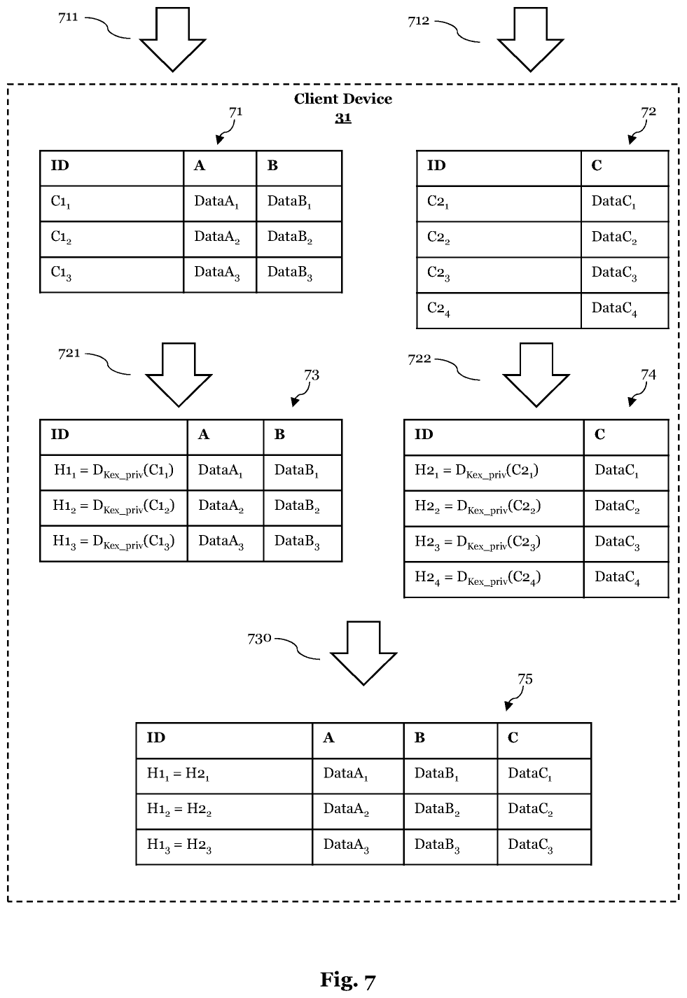

FIG. 7 illustrates the operations performed at the client device, within the framework of the first embodiment of the invention.

Client device 31 receives structured data sets from data source devices, containing encrypted digital footprints with the associated data, for example as data tables 71, 72 (steps 711 and 712). Then, client device 31 decrypts the encrypted digital footprints to obtain the corresponding digital footprints (steps 721 and 722), as illustrated in data tables 73, 74 (in accordance with the method described in FIG. 3).

The digital footprints of data tables 73, 74 are compared and combined so as to generate a join set, for example data table 75 at step 730. In the example of FIG. 7, an internal join (as explained with reference to FIG. 1) is carried out. Hence, in data table 75, there is no value corresponding to identifier ID2₄ of table 62 FIG. 6.

In data table 75, the matching digital footprints are stored with the A-type, B-type and C-type data. The client can hence use the combined data coming from the two data source devices.

Client device 31 and data source devices 21, 22 may be computer devices including a memory configured to store instructions for executing the instructions illustrated in FIGS. 2 to 7. Moreover, these computer devices may include one or several processors for processing the instructions stored in memory. Client device 31 and data source devices 21 and 22 may be communicatively connected through a bus system or via a wired or wireless communication network, for example the Internet. In an example, client device 31, first data source device 21 and/or second data source device 22 may belong to a same computer device, for example a same server and/or use a same dematerialized storage (“cloud”). Data source devices 21, 22 may be servers including a database management software for storing the data to be sent to client device 31.

Of note, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, and/or “including,” when used in this specification, specify the presence of stated features, integers, steps, operations, elements, and/or components, but do not preclude the presence or addition of one or more other features, integers, steps, operations, elements, components, and/or groups thereof.

As well, the corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for matching evaluation of a first structured data set from a first data source device with a second structured data set from a second data source device, implemented in a client device, wherein the method comprises the following steps:
a. exchange of an encryption key between the client device, the first data source device and the second data source device;
b. reception of the first structured data set from the first data source device, the first structured data set comprising a first encrypted digital footprint generated from a first digital footprint and the encryption key, the first digital footprint being generated from a first identifier in clear and a secret key that is shared between the first and second data source device;
c. reception of the second structured data set from the second data source device, the second structured data set comprising a second encrypted digital footprint generated from a second digital footprint and the encryption key, the second digital footprint being generated from a second identifier in clear and the shared secret key;
d. comparison of the first encrypted digital footprint of the first structured data set with the second encrypted digital footprint of the second structured data set in order to determine if the first identifier in clear is identical to the second identifier in clear without having access to the first and second identifiers in clear, the first digital footprint of the first structured data set having a value different from that of the second encrypted digital footprint of the second structured data set.

2. The method according to claim 1, wherein the encryption key is a public key of the client device.

3. The method according to claim 2, wherein the comparison step is based on the decryption of the first encrypted digital footprint of the first structured data set and of the second encrypted digital footprint of the second structured data set by means of a private key of the client device.

4. The method according to claim 1, wherein
the encryption key comprises a first symmetric key exchanged between the client device and the first data source device and a second symmetric key exchanged between the client device and the second data source device;
the encryption key used to generate the first encrypted digital footprint of the first structured data set is the first symmetric key and
the encryption key used to generate the second encrypted digital footprint of the second structured data set is the second symmetric key.

5. The method according to claim 4, wherein the comparison step is based on the decryption of the first encrypted digital footprint of the first structured data set by means of the first symmetric key and on the decryption of the second encrypted digital footprint of the second structured data set by means of the second symmetric key.

6. The method according to claim 1,
wherein the encryption key is a symmetric key shared between the client device, the first data source device and the data source device;
wherein the first encrypted digital footprint of the first structured data set is further generated from a first random value and the first structured data set further comprises the first random value;
wherein the second encrypted digital footprint of the second structured data set is further generated from a second random value and the second structured data set further comprises the second random value; and
wherein the comparison step is further carried out by means of the first and the second random values.

7. The method according to claim 6, wherein the comparison step is based on the decryption of the first encrypted digital footprint of the first structured data set by means of the first random value and the shared symmetric key and on the decryption of the second encrypted digital footprint of the second structured data set by means of the second random value and the shared symmetric key.

8. The method according to claim 2, wherein the comparison step is based on an homomorphic property of an encryption algorithm used to generate the first encrypted digital footprint of the first structured data set and to generate the second encrypted digital footprint of the second structured data set.

9. The method according to claim 1,
wherein the first digital footprint is further generated from a given functional value, this given functional value defining the possible functions of use of the shared secret key; and
wherein the second digital footprint is further generated from the given functional value.

10. The method according to claim 2,
wherein the comparison step is based on an homomorphic property of an encryption algorithm used to generate the first encrypted digital footprint of the first structured data set and to generate the second encrypted digital footprint of the second structured data set; and
wherein the comparison step comprises an homomorphic operation of the first digital footprint of the first structured data set with the second encrypted digital footprint of the second structured data set.

11. The method according to claim 1,
wherein the first and/or the second structured data sets further comprise data associated with the first encrypted digital footprint of the first structured data set and with the second encrypted digital footprint of the second structured data set; and
wherein the method comprises a step of inserting, into a join set, data associated with the first encrypted digital footprint of the first structured data set and/or data associated with the second encrypted digital footprint of the second structured data set when the result of the comparison step determines that the first identifier in clear is identical to the second identifier in clear.

12. The method according to claim 1, wherein the first structured data set
comprises a plurality of first encrypted digital footprints and/or the second structured data set comprises a plurality of second encrypted digital footprints,
the comparison step is carried out for one or several first encrypted digital footprints of the first structured data set and one or several second encrypted digital footprints of the second structured data set.

13. The method according to claim 11,
wherein the first structured data set comprises a plurality of first encrypted digital footprints and/or the second structured data set comprises a plurality of second encrypted digital footprints; and
wherein the comparison step and the step of insertion into a join set are carried out for one or several first encrypted digital footprints of the first structured data set and one or several second encrypted digital footprints of the second structured data set.

14. A method for providing a structured data set to a client device, implemented in a data source device, the method comprising the following steps:
i. exchange of an encryption key between the client device, the data source device and a second data source device,
ii. creation of a digital footprint from an identifier in clear and a secret key that is shared with the second data source device,
iii. generation of an encrypted digital footprint from the digital footprint and the encryption key,
iv. sending to the client device of a structured data set comprising the encrypted digital footprint in order to carry out a matching evaluation with another structured data set coming from the second data source device.

15. A computer device including a memory configured to store instructions for executing instructions comprising one or several processors for processing the instructions stored in memory, the device communicatively coupled to clients and data sources through a bus system or via a wired or wireless communication network, the instructions performing the following steps:
i. exchange of an encryption key between the client device, the data source device and a second data source device,
ii. creation of a digital footprint from an identifier in clear and a secret key that is shared with the second data source device,
iii. generation of an encrypted digital footprint from the digital footprint and the encryption key,
iv. sending to the client device of a structured data set comprising the encrypted digital footprint in order to carry out a matching evaluation with another structured data set coming from the second data source device.
